(19) United States
(12) Patent Application Publication
(10) Pub. No.: US 2023/0421707 A1
(43) Pub. Date: Dec. 28, 2023

(54) IMAGE FORMING DEVICE, FACSIMILE PROCESSING SYSTEM, AND FACSIMILE PROCESSING METHOD

(71) Applicant: TOSHIBA TEC KABUSHIKI KAISHA, Tokyo (JP)

(72) Inventor: Masami Taoda, Fuchu Tokyo (JP)

(21) Appl. No.: 17/851,108

(22) Filed: Jun. 28, 2022

(51) Int. Cl. H04N 1/00; H04N 1/44

(52) U.S. Cl. CPC H04N 1/00307; H04N 1/00567; H04N 1/4433

(57) ABSTRACT

An image forming device including a facsimile communication module, a printer, and a control circuit is provided. The facsimile communication module is configured to receive facsimile data. The printer is configured to form, on a sheet, an image based on the facsimile data. The control circuit is configured to extract an address from the facsimile data and control a voice notification to a telephone number related to the address.

### FIELD

Embodiments described herein relate to an image forming device, a facsimile processing system, and a facsimile processing method.

### BACKGROUND

Image forming devices having a copy function, a print function, a facsimile function, a scanner function, and the like have been provided. Usually, the image forming device is provided in an office or the like as a device shared by a plurality of users.

Usually, in offices or the like, a person is assigned in charge of checking a facsimile print. However, even though the person in charge checks the facsimile print, it is difficult to determine whether the facsimile is urgent. Due to the determination of the person in charge, the response to the facsimile communication may be delayed.

Since the image forming device has the above-described plurality of functions, various prints are ejected to the same tray. For this reason, forgetting to take the facsimile print by the person in charge causes security issues in which the facsimile print may be lost or may be taken away by another person.

### DESCRIPTION OF THE DRAWINGS

FIG. 1 is a block diagram illustrating a facsimile processing system according to an embodiment;

FIG. 2 is an external view illustrating an image forming device;

FIG. 3 is a block diagram illustrating the image forming device;

FIG. 4 is a diagram illustrating a data structure of user data stored in the image forming device;

FIG. 5 is a diagram illustrating facsimile data received by the image forming device;

FIG. 6 is a diagram illustrating voice text data created by the image forming device;

FIG. 7 is a flowchart showing a first example of a facsimile process in the image forming device;

FIG. 8 is a flowchart showing a second example; and

FIG. 9 is a flowchart showing a third example.

### DETAILED DESCRIPTION

In general, according to one embodiment, an image forming device including a facsimile communication module, a printer, and a control circuit is provided. The facsimile communication module is configured to receive facsimile data. The printer is configured to form, on a sheet, an image based on the facsimile data. The control circuit is configured to extract an address from the facsimile data and control a voice notification to a telephone number related to the address.

Hereinafter, the embodiment will be described with reference to drawings.

### System Configuration

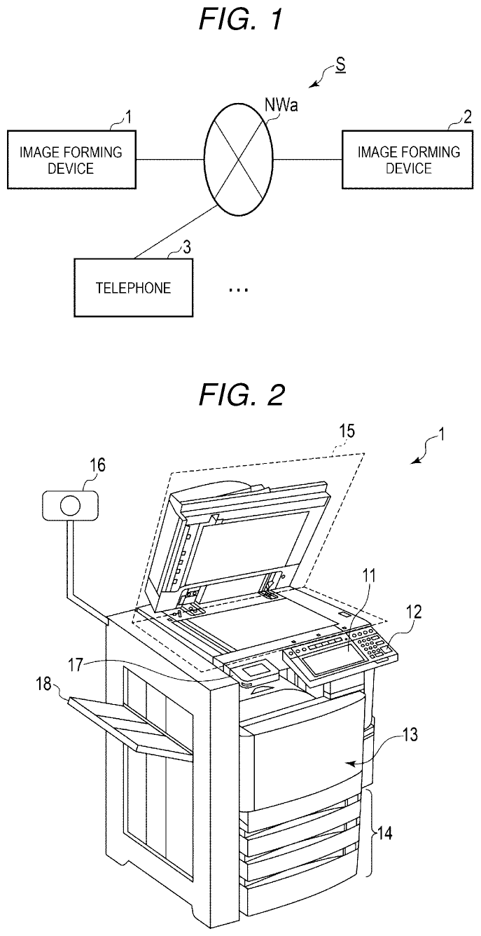

FIG. 1 is a block diagram illustrating a facsimile processing system S.

The facsimile processing system S includes an image forming device 1, an image forming device 2, and a plurality of telephones 3. The image forming device 1, the image forming device 2, and the plurality of telephones 3 are connected to one another via a network NWa. The network NWa is a telephone line network capable of communicating voice data or facsimile data. The facsimile data is encoded data. The facsimile processing system S may include three or more image forming devices. The facsimile processing system S may refer to a system including at least two of the image forming device 1, the image forming device 2, and the plurality of telephones 3.

The image forming device 1 and the image forming device 2 are electronic devices including an electrophotographic printing function. The image forming device 1 and the image forming device 2 will be described as being a multifunction peripheral (MFP) having a copy function, a print function, a facsimile function, a scanner function, and the like. The image forming device 1 is an example of a first image forming device. The image forming device 2 is an example of a second image forming device. A configuration example of the image forming device 1 will be described later. The configuration of the image forming device 2 may be the same as the configuration of the image forming device 1, and the description of the configuration of the image forming device 2 will be omitted.

The telephone 3 is an electronic device capable of making a voice call based on the voice data. The telephone 3 may be a fixed telephone that can be connected to the network NWa by wire. The telephone 3 may be a mobile terminal that is wirelessly connected to the network NWa.

Device Configuration

FIG. 2 is an external view illustrating the image forming device 1.

The image forming device 1 includes a display device 11, an input device 12, a printer 13, a paper feed unit 14, a scanner unit 15, a camera 16, a card reader 17, and a tray 18.

The display device 11 is a device capable of displaying an image. For example, the display device 11 is a liquid crystal display, an electroluminescence (EL) display, or the like. The display device 11 may be a touch panel formed together with the input device 12.

The input device 12 is a device capable of inputting an instruction based on an operation of a user. The input device 12 may include a button-type input key. The input device 12 may be a touch panel formed together with the display device 11.

The printer 13 is a unit that forms an image on a sheet. The sheet on which the image is formed by the printer 13 is also referred to as a print. For example, the sheet is paper, and may also be a medium other than paper. On the medium, the image can be formed.

The paper feed unit 14 is a unit that feeds the sheet to the printer 13. The paper feed unit 14 includes one or more paper feed units that accommodate the sheet. The paper feed unit 14 includes one or more pickup rollers that take out sheets one by one from each of the one or more paper feed units and supply the sheets to the printer 13.

The scanner unit 15 is a device that reads images such as characters, figures, and photographs from the sheet. The scanner unit 15 includes a line sensor. The line sensor may be a charge coupled device (CCD) system. The line sensor may be a contact image sensor (CIS) system. The scanner unit 15 generates image data based on an image read using the line sensor.

The camera 16 is a device having a filming function. The camera 16 acquires filming data of a still image or a moving image based on the filming. The filming range of the camera 16 covers the tray 18. The filming range of the camera 16 may cover the vicinity of the image forming device 1. The filming data acquired by the camera 16 is an example of sensing data for detecting the presence or absence of the print in the tray 18. The camera 16 is an example of a sensing device that acquires the sensing data.

The card reader 17 is an electronic device that reads identification information from an information recording medium. For example, the card reader 17 is a non-contact card reader. The information recording medium is a medium that stores the identification information. For example, the information recording medium is an integrated circuit (IC) card. The information recording medium includes a chip and an antenna. The chip controls the information recording medium. The chip includes a storage area for information. The storage area stores the identification information. The antenna is used to communicate wirelessly with external devices. The antenna is used to receive power from the external devices. The information recording medium is activated by receiving radio waves from the external devices via the antenna. The information recording medium communicates, by activation, with the external devices. The identification information is information with which each user can be identified. The identification information is information used for user authentication executed by the image forming device 1. The authentication includes logging in to the image forming device 1.

The tray 18 is a tray on which the print ejected from the printer 13 is placed. The tray 18 may be provided in the image forming device 1 in such a manner that the print can be carried.

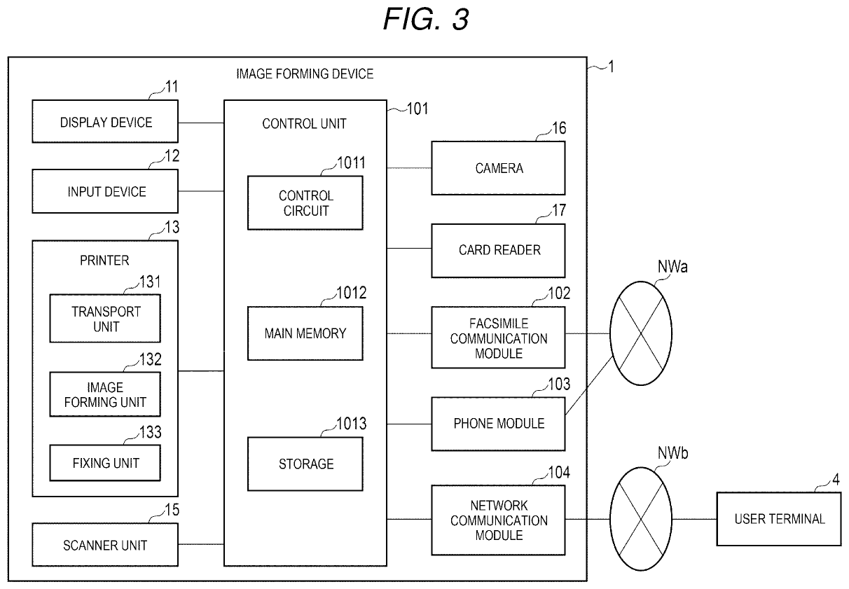

FIG. 3 is a block diagram illustrating the image forming device 1.

The above-described printer 13 includes a transport unit 131, an image forming unit 132, and a fixing unit 133.

The transport unit 131 transports the sheet in the printer 13. The transport unit 131 includes a plurality of rollers and a resist roller. The plurality of rollers include a roller that transports the sheet supplied by the pickup roller from the paper feed unit 14 to the resist roller. The plurality of rollers are provided downstream of the fixing unit 133, which will be described later, and include rollers that eject the sheet to the tray 18. According to the timing at which a transfer unit of the image forming unit 132, which will be described later, transfers a toner image to the sheet, the resist roller transports the sheet to the transfer unit.

The image forming unit 132 forms the toner image on the sheet. The image forming unit 132 includes an intermediate transfer belt, a plurality of developing units, an exposure device, the transfer unit, and the like.

The intermediate transfer belt is an endless belt.

The plurality of developing units correspond to the number of types of toner. The plurality of developing units include a black developing unit, a cyan developing unit, a magenta developing unit, and a yellow developing unit. Each of the developing units includes a photoconductor drum. Each of the developing units includes a charger, a developing device, a primary transfer roller, a cleaning unit, and a static eliminator around the photoconductor drum. The photoconductor drum is a drum having a photoconductor layer on the surface. The charger uniformly charges the photoconductor layer on the surface of the photoconductor drum. The developing device develops an electrostatic latent image on the surface of the photoconductor drum with the toner. The developing device forms the toner image on the surface of the photoconductor drum. The primary transfer roller faces the photoconductor drum and sandwiches the intermediate transfer belt. The primary transfer roller transfers the toner image on the surface of the photoconductor drum onto the intermediate transfer belt. The cleaning unit removes untransferred toner on the surface of the photoconductor drum. The static eliminator irradiates the surface of the photoconductor drum with light. The static eliminator removes static electricity from the photoconductor layer of the photoconductor drum by irradiation with light.

The exposure device irradiates the surfaces of the photoconductor drums of the developing units with a laser beam via an optical system such as a polygon mirror. The exposure device forms an electrostatic pattern on the surfaces of the photoconductor drums as the electrostatic latent image.

The transfer unit transfers the charged toner image on the surface of the intermediate transfer belt to paper. The transfer unit includes a support roller and a secondary transfer roller that sandwich the intermediate transfer belt and the paper from both sides in the thickness direction.

The fixing unit 133 applies heat and pressure to the sheet on which the toner image supplied from the image forming unit 132 is formed. The fixing unit 133 fixes the toner image formed on the sheet by heat and pressure.

As shown in FIG. 2, the image forming device 1 includes a control unit 101, a facsimile communication module 102, a telephone module 103, and a network communication module 104.

The control unit 101 controls the operation of each unit of the image forming device 1. The control unit 101 includes a control circuit 1011, a main memory 1012, and a storage 1013.

The control circuit 1011 corresponds to a central portion of the image forming device 1. The control circuit 1011 is an element constituting a computer of the image forming device 1. The control circuit 1011 includes a processor such as a central processing unit (CPU). The control circuit 1011 may include various circuits such as an application specific integrated circuit (ASIC), a field programmable gate array (FPGA), or a graphics processing unit (GPU) in addition to or in place of the CPU. The control circuit 1011 loads the program stored in the main memory 1012 or the storage 1013 into the main memory 1012. The control circuit 1011 executes various processes by executing the program loaded in the main memory 1012.

The main memory 1012 corresponds to a main storage portion of the image forming device 1. The main memory 1012 is an element constituting the computer of the image forming device 1. The main memory 1012 includes a non-volatile memory area and a volatile memory area. The main memory 1012 stores an operating system or a program in the non-volatile memory area. The main memory 1012 uses the volatile memory area as a work area where data is appropriately rewritten by the control circuit 1011. For example, the main memory 1012 includes a read only memory (ROM) as the non-volatile memory area. For example, the main memory 1012 includes a random access memory (RAM) as the volatile memory area. The main memory 1012 is an example of a memory or a storage device.

The storage 1013 corresponds to an auxiliary storage portion of the image forming device 1. The storage 1013 is an element constituting the computer of the image forming device 1. For example, the storage 1013 includes a hard disk drive (HDD). The storage 1013 may include a semiconductor storage medium such as a solid state drive (SSD) in addition to or in place of the HDD. The storage 1013 stores the above-described program, data used by the control circuit 1011 for performing various processes, and data generated by the process of the control circuit 1011. The storage 1013 is an example of a memory or a storage device.

The facsimile communication module 102 is a module that can be connected to the network NWa. The facsimile communication module 102 is a module related to a process of facsimile. The facsimile communication module 102 transmits the facsimile data addressed to another electronic device from the image forming device 1 via the network NWa. The facsimile communication module 102 receives the facsimile data addressed to the image forming device 1 from the other electronic device via the network NWa.

The telephone module 103 is a module that can be connected to the network NWa. The telephone module 103 is a module related to a process of a telephone. The telephone module 103 dials a telephone number of the telephone 3. The telephone module 103 converts voice text data into voice data. The voice text data is text data of a telephone sentence. The telephone module 103 transmits the voice data addressed to the telephone 3 from the image forming device 1 via the network NWa.

The network communication module 104 is a module that can be connected to a network NWb. The network communication module 104 freely communicates with a user terminal 4 via the network NWb. For example, the network NWb includes one or more of various networks such as the Internet and a local area network (LAN). The one or more networks may include a wireless network or a wired network.

The user terminal 4 is an electronic device capable of processing information. For example, the user terminal 4 is, but is not limited to, a personal computer (PC), a tablet terminal, a smartphone, or the like. The user terminal 4 transmits print data to the image forming device 1. The print data is data of a job related to printing requested from the user terminal 4 to the image forming device 1. The print data includes image data to be printed specified by the user terminal 4. The print data includes user identification information.

The hardware configuration of the image forming device 1 is not limited to the above configuration. In the image forming device 1, it is possible to omit or change the above-described components and add new components as appropriate. At least one of the camera 16 and the card reader 17 may be separate from the image forming device 1.

User Data

User data stored in the above-described storage 1013 will be described.

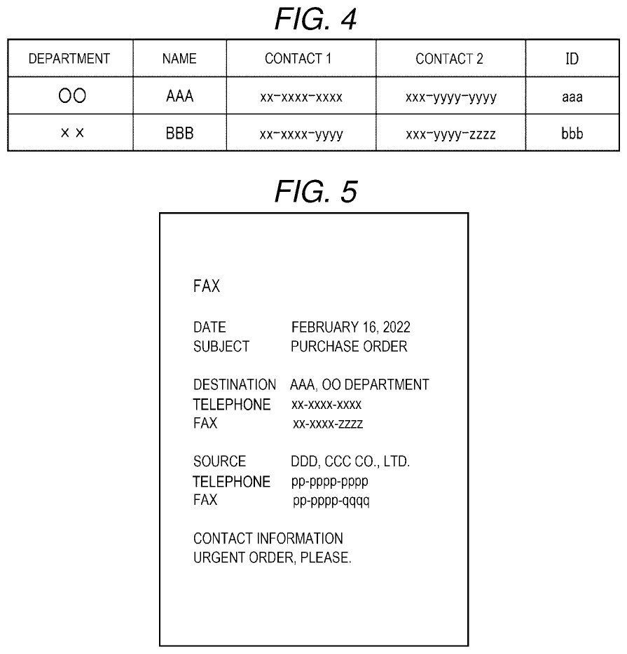

FIG. 4 is a diagram illustrating a data structure of the user data stored in the storage 1013 of the image forming device 1.

The user data includes data related to each of a plurality of users who use the image forming device 1. The user data includes, for each user, the name of the user and one or more telephone numbers of the user. The telephone number is an example of a contact. The user data may include, for each user, the department to which the user belongs. The user data includes, for each user, user identification information such as a user ID. The user data may include, for each user, one or more email addresses of the user. The email address is an example of the contact.

Facsimile Data

Facsimile data received by the above-described facsimile communication module 102 will be described.

FIG. 5 is a diagram illustrating the facsimile data received by the facsimile communication module 102 of the image forming device 1.

The facsimile data includes date, a subject, a destination, a source, and contact information. The destination includes the name, department, telephone number and facsimile number of the destination. The source includes the name, department, telephone number and facsimile number of the source. The contact information includes the content of the contact.

Voice Text Data

Voice text data created by the above-described control circuit 1011 will be described.

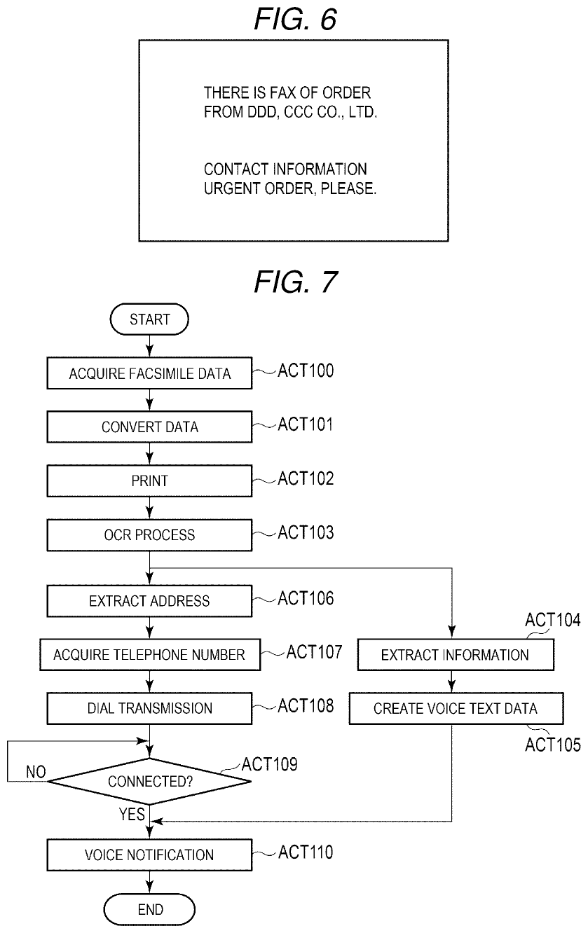

FIG. 6 is a diagram illustrating the voice text data created by the control circuit 1011 of the image forming device 1.

The control circuit 1011 creates the voice text data based on the facsimile data. The voice text data includes the source of the facsimile data. In the example in FIG. 6, the voice text data includes “DDD, CCC Co., Ltd.” as the source of the facsimile data. The voice text data may include the subject of the facsimile data. In the example in FIG. 6, the voice text data includes a “purchase order” as the subject of the facsimile data. The voice text data may include the content of the contact of the facsimile data. In the example in FIG. 6, the voice text data includes “urgent order, please” as the content of the contact of the facsimile data. If the facsimile data includes a predetermined keyword, the voice text data may include the predetermined keyword. The predetermined keyword may be included in the content of the contact. The predetermined keyword is a word indicating urgency. The predetermined keyword is, but is not limited to, “urgent” or the like. The storage 1013 may store data of one or more predetermined keywords. One or more predetermined keywords can be appropriately set. In the example in FIG. 6, the voice text data includes “urgent” as the predetermined keyword.

Control Operation

FIG. 7 is a flowchart showing a first example of a facsimile process in the image forming device 1.

The processing procedure described below is only an example, and each process may be changed as much as possible. As the processing procedure, each process can be omitted or replaced according to the embodiment, and a new process can be added.

The control circuit 1011 acquires facsimile data (ACT 100). In ACT 100, for example, the control circuit 1011 acquires facsimile data received by the facsimile communication module 102. The facsimile communication module 102 receives facsimile data transmitted from the image forming device 2.

The control circuit 1011 converts the facsimile data into image data (ACT 101). In ACT 101, for example, the control circuit 1011 converts the facsimile data into image data by decoding the facsimile data. Converting the facsimile data into the image data is an example of an image codec process. In the following, the image data converted from facsimile data is also referred to as facsimile image data. The control circuit 1011 stores the facsimile image data in the storage 1013.

The control circuit 1011 controls the printer 13 to form, on a sheet, an image based on the facsimile image data (ACT 102). In ACT 102, for example, the control circuit 1011 transmits the facsimile image data stored in the storage 1013 to the printer 13. The control circuit 1011 controls printing performed by the printer 13 so as to form, on a sheet, an image based on the facsimile image data. In the following, the image based on the facsimile image data is also referred to as a facsimile image. The printer 13 forms the facsimile image on the sheet based on the control executed by the control circuit 1011. The printer 13 ejects, to the tray 18, the sheet on which the facsimile image is formed based on the formation of the facsimile image on the sheet. In the following, the sheet on which the facsimile image is formed is also referred to as a facsimile print. The tray 18 carries the facsimile print. Forming, on the sheet, the image based on the facsimile image data is an example of forming, on the sheet, an image based on the facsimile data.

The control circuit 1011 executes an optical character recognition (OCR) process on the facsimile image data (ACT 103). In ACT 103, for example, the control circuit 1011 acquires the facsimile image data stored in the storage 1013. The control circuit 1011 converts the facsimile image data into text data by the OCR process on the facsimile image data. The OCR process on the facsimile image data is an example of an image recognition process. In the following, the text data converted from the facsimile image data is also referred to as facsimile text data.

The control circuit 1011 extracts information from the facsimile text data (ACT 104). In ACT 104, for example, the control circuit 1011 extracts, from the facsimile text data, information for creating voice text data. Extracting the information from the facsimile text data is an example of extracting information from facsimile data. The control circuit 1011 extracts the source of the facsimile data from the facsimile text data. The control circuit 1011 may extract the subject of the facsimile data from the facsimile text data. The control circuit 1011 may extract the content of the contact of the facsimile data from the facsimile text data. If the facsimile text data includes a predetermined keyword, the control circuit 1011 may extract the predetermined keyword from the facsimile text data. The facsimile text data including the predetermined keyword is an example of the facsimile data including the predetermined keyword.

The control circuit 1011 creates voice text data (ACT 105). In ACT 105, for example, the control circuit 1011 creates voice text data including the information extracted from the facsimile text data.

The control circuit 1011 extracts an address from the facsimile text data (ACT 106). In ACT 106, for example, the control circuit 1011 extracts the name of the destination as the address. Extracting the address from the facsimile text data is an example of extracting the address from the facsimile data.

The control circuit 1011 acquires a telephone number based on the address (ACT 107). In ACT 107, for example, the control circuit 1011 acquires, from user data, a telephone number related to the address of the facsimile data associated with a name which is the address.

The control circuit 1011 controls the telephone module 103 to control a dial transmission (ACT 108). In ACT 108, for example, the control circuit 1011 controls the telephone module 103 to dial the telephone number related to the address. The telephone module 103 dials the telephone number related to the address.

The control circuit 1011 determines whether the telephone number related to the address is connected (ACT 109). In ACT 109, for example, the control circuit 1011 determines whether the telephone number related to the address is connected based on the dial executed by the telephone module 103. If the control circuit 1011 determines that the telephone number related to the address is not connected (ACT 109, NO), the control circuit 1011 continues the process of ACT 109. If the control circuit 1011 determines that the telephone number related to the address is connected (ACT 109, YES), the process transitions from ACT 109 to ACT 110.

The control circuit 1011 controls a voice notification to the telephone number related to the address (ACT 110). In ACT 110, for example, the control circuit 1011 controls the telephone module 103 to control the transmission of voice data based on the voice text data. The control circuit 1011 transmits the voice text data to the telephone module 103. The control circuit 1011 controls the telephone module 103 so as to transmit the voice data based on the voice text data to the telephone 3 having the telephone number related to the address. The voice data includes the source of the facsimile data. The voice data may include the subject of the facsimile data. The voice data may include the content of the contact of the facsimile data. The voice data may include a predetermined keyword. The voice data is an example of the voice notification. The telephone module 103 converts the voice text data into the voice data. The telephone module 103 transmits the voice data to the telephone 3 having the telephone number related to the address via the network NWa.

According to the above-described first example, the image forming device 1 can control the voice notification to the telephone number related to the address extracted from the facsimile data. Accordingly, the image forming device 1 can reliably notify the user at the address of the facsimile data of the reception of the facsimile data by voice. The image forming device 1 can prevent the facsimile print from being left on the tray 18. Thus, the image forming device 1 can prevent the security issues in which the facsimile print may be lost or may be taken away by another person.

According to the above-described first example, the voice notification may include a predetermined keyword. Accordingly, the image forming device 1 can notify the user of a predetermined keyword indicating urgency or the like by voice. The image forming device 1 can prompt the user to determine whether a matter is an important matter that requires urgency.

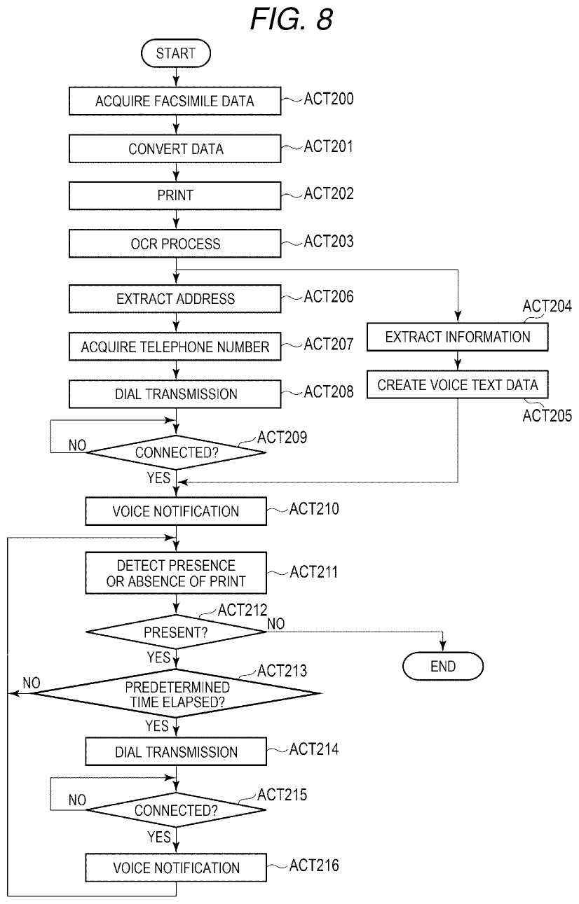

FIG. 8 is a flowchart showing a second example of the facsimile process in the image forming device 1.

The processing procedure described below is only an example, and each process may be changed as much as possible. As the processing procedure, each process can be omitted or replaced according to the embodiment, and a new process can be added.

Processes of ACT 200 to ACT 210 executed by the control circuit 1011 may be the same as the processes of ACT 100 to ACT 110 executed by the control circuit 1011, and the descriptions thereof will be omitted.

The control circuit 1011 detects the presence or absence of a facsimile print in the tray 18 based on filming data acquired by the camera 16 (ACT 211). In ACT 211, for example, the control circuit 1011 acquires filming data from the camera 16 with the tray 18 as the filming range. The control circuit 1011 detects the presence or absence of the facsimile print in the tray 18 based on whether the facsimile print is included in the filming data. If the filming data includes some print on the tray 18, the control circuit 1011 determines that the facsimile print is included in the filming data. The control circuit 1011 detects that the facsimile print is present in the tray 18 based on the determination result that the facsimile print is included in the filming data. If the filming data does not include any print on the tray 18, the control circuit 1011 determines that the facsimile print is not included in the filming data. The control circuit 1011 detects that the facsimile print is not present in the tray 18 based on the determination result that the facsimile print is not included in the filming data.

If the control circuit 1011 detects that the facsimile print is not present in the tray 18 (ACT 212, NO), the process ends. For example, if a user at the address of the facsimile data took the facsimile print from the tray 18, the facsimile print is not present in the tray 18.

If the control circuit 1011 detects that the facsimile print is present in the tray 18 (ACT 212, YES), the process transitions from ACT 212 to ACT 213. If the user at the address of the facsimile data does not take the facsimile print from the tray 18, the facsimile print is present in the tray 18.

The control circuit 1011 determines whether a predetermined time elapsed from the control of a first voice notification (ACT 213). The first voice notification is the latest voice notification that is the starting point of the predetermined time. The length of the predetermined time can be set as appropriate. If the predetermined time does not elapse from the control of the first voice notification (ACT 213, NO), the process transitions from ACT 213 to ACT 211. If the predetermined time elapsed from the control of the first voice notification (ACT 213, YES), the process transitions from ACT 213 to ACT 214. Accordingly, the control circuit 1011 detects that the facsimile print is present in the tray 18 after the predetermined time elapsed, based on the filming data acquired by the camera 16.

The control circuit 1011 controls the telephone module 103 to control a dial transmission (ACT 214). The process of ACT 214 may be the same as the process of ACT 108, and the description thereof will be omitted.

The control circuit 1011 determines whether the telephone number related to the address is connected (ACT 215). The process of ACT 215 may be the same as the process of ACT 109, and the description thereof will be omitted. If the control circuit 1011 determines that the telephone number related to the address is not connected (ACT 215, NO), the control circuit 1011 continues the process of ACT 215. If the control circuit 1011 determines that the telephone number related to the address is connected (ACT 215, YES), the process transitions from ACT 215 to ACT 216.

The control circuit 1011 controls a second voice notification to the telephone number related to the address (ACT 216). In ACT 216, for example, if the facsimile print is present in the tray 18 after a predetermined time elapsed from the control of the first voice notification, the control circuit 1011 controls the second voice notification to the telephone number related to the address after the predetermined time elapsed. The process of ACT 216 may be the same as the process of ACT 210, and the description thereof will be omitted. The second voice notification is a voice notification controlled after a predetermined time elapsed from the control of the first voice notification. The voice data in the second voice notification may be the same as or different from the voice data in the first voice notification. If the voice data in the second voice notification is different from the voice data in the first voice notification, the voice data in the second voice notification may include a case of re-notification.

The control circuit 1011 repeats the processes of ACT 211 to ACT 216 until the control circuit 1011 detects that the facsimile print is not present in the tray 18.

According to the above-described second example, the image forming device 1 can detect the presence or absence of the facsimile print in the tray 18 based on the sensing data. Based on the sensing data, the image forming device 1 can detect that the facsimile print is present in the tray 18 after the predetermined time elapsed from the control of the first voice notification. Accordingly, the image forming device 1 can continuously detect the presence or absence of the facsimile print in the tray 18 after the control of the first voice notification.

According to the above-described second example, the image forming device 1 can control the second voice notification if the facsimile print is present in the tray 18 after the predetermined time elapsed from the control of the first voice notification. Accordingly, the image forming device 1 can control repeated voice notifications at predetermined time intervals if the facsimile print is present in the tray 18. The image forming device 1 can prevent the facsimile print from being left on the tray 18.

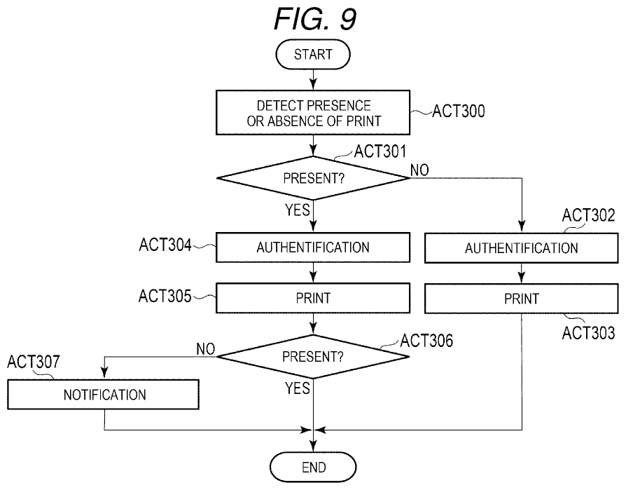

FIG. 9 is a flowchart showing a third example of the facsimile process in the image forming device 1.

The processing procedure described below is only an example, and each process may be changed as much as possible. As the processing procedure, each process can be omitted or replaced according to the embodiment, and a new process can be added.

The third example can be combined with the first example or the second example. The third example may be combined after the printer 13 ejects the facsimile print to the tray 18 in the process of ACT 102 in the first example. The third example may be combined after the printer 13 ejects the facsimile print to the tray 18 in the process of ACT 202 in the second example.

In the third example, the user at the address of the facsimile data is a first user. It is assumed that the image forming device 1 is used by a second user different from the first user.

The control circuit 1011 detects the presence or absence of a facsimile print in the tray 18 based on filming data acquired by the camera 16 (ACT 300). The process of ACT 300 may be the same as the process of ACT 211, and the description thereof will be omitted.

If the control circuit 1011 detects that the facsimile print is not present in the tray 18 (ACT 301, NO), the process transitions from ACT 301 to ACT 302. If the control circuit 1011 detects that the facsimile print is present in the tray 18 (ACT 301, YES), the process transitions from ACT 301 to ACT 304.

The control circuit 1011 detects, based on authentication of the second user, that the second user uses the image forming device 1 (ACT 302). In ACT 302, for example, the control circuit 1011 authenticates the second user via the card reader 17. Authenticating the second user includes identifying or permitting the second user as the user who uses the image forming device 1. The card reader 17 is an example of an electronic device for authentication. The control circuit 1011 acquires the identification information of the second user from the information recording medium via the card reader 17. The control circuit 1011 collates the identification information of the second user with the identification information of each user included in the user data. The control circuit 1011 authenticates the second user if the identification information of the second user matches any piece of the identification information of each user included in the user data. The control circuit 1011 detects, based on the authentication of the second user, that the second user uses the image forming device 1. The use of the image forming device 1 by the second user includes printing an image based on the image data related to the second user by the printer 13. The image data related to the second user may be image data generated by the scanner unit 15 based on the use of the scanner unit 15 by the second user. The image data related to the second user may be image data included in the print data transmitted from the user terminal 4 of the second user to the image forming device 1.

The control circuit 1011 controls the printer 13 to form, on a sheet, the image based on the image data related to the second user (ACT 303). In ACT 303, for example, the control circuit 1011 controls printing performed by the printer 13 so as to form, on the sheet, an image based on the image data related to the second user. The printer 13 forms, on the sheet, the image based on the image data related to the second user according to the control executed by the control circuit 1011. In the following, the sheet on which the image based on the image data related to the second user is formed is also referred to as a print of the second user. The printer 13 ejects the print of the second user to the tray 18 based on the formation of the image on the sheet. The tray 18 carries the print of the second user.

The control circuit 1011 detects, based on the authentication of the second user, that the second user uses the image forming device 1 (ACT 304). The process of ACT 304 may be the same as the process of ACT 302, and the description thereof will be omitted.

The control circuit 1011 controls the printer 13 to form, on the sheet, the image based on the image data related to the second user (ACT 305). The process of ACT 305 may be the same as the process of ACT 303, and the description thereof will be omitted. The printer 13 ejects the print of the second user into the tray 18 such that the print of the second user is carried on the facsimile print. The tray 18 carries the print of the second user. The print of the second user is on the facsimile print.

The control circuit 1011 detects the presence or absence of the facsimile print in the tray 18 based on the filming data acquired by the camera 16 (ACT 306). In ACT 306, for example, the control circuit 1011 detects the presence or absence of the facsimile print in the tray 18 based on whether the facsimile print is included in the filming data. The second user may leave the facsimile print and take only the print of the second user, but may mistakenly take both the facsimile print and the print of the second user. Thus, if the filming data includes some print on the tray 18, the control circuit 1011 determines that the facsimile print is included in the filming data. The control circuit 1011 detects that the facsimile print is present in the tray 18 based on the determination result that the facsimile print is included in the filming data. If the filming data does not include any print on the tray 18, the control circuit 1011 determines that the facsimile print is not included in the filming data. The control circuit 1011 detects that the facsimile print is not present in the tray 18 based on the determination result that the facsimile print is not included in the filming data.

If the control circuit 1011 detects that the facsimile print is present in the tray 18 (ACT 306, YES), the process ends. If the control circuit 1011 detects that the facsimile print is not present in the tray 18 (ACT 306, NO), the process transitions from ACT 306 to ACT 307.

The control circuit 1011 controls a notification to a contact related to the second user (ACT 307). The process of ACT 307 is a process in which the facsimile print present in the tray 18 before the second user uses the image forming device 1 is not present in the tray 18 after the second user uses the image forming device 1. The case before the second user uses the image forming device 1 includes a case before the image forming device 1 authenticates the second user. The case after the second user uses the image forming device 1 includes a case after the printer 13 ejects the print of the second user to the tray 18.

The notification to the contact related to the second user is a notification related to a case of mistakenly taking away the facsimile print. The notification to the contact related to the second user includes a message of mistakenly taking away the facsimile print. The notification to the contact related to the second user may include the name of the first user at the address of the facsimile data, which is the original target of the facsimile print. The notification to the contact related to the second user includes at least either one of a voice notification or a mail notification.

A case will be described in which the notification to the contact related to the second user includes the voice notification. The control circuit 1011 acquires, from the user data, a telephone number associated with the identification information of the second user. The control circuit 1011 controls the telephone module 103 to control the voice notification to the telephone number related to the second user. The control circuit 1011 controls the telephone module 103 to control the transmission of the voice data related to the case of mistakenly taking away the facsimile print. The voice data includes the message of mistakenly taking away the facsimile print. The voice data may include the name of the first user at the address of the facsimile data. The telephone module 103 transmits the voice data to the telephone 3 having a telephone number related to the second user via the network NWa.

A case will be described in which the notification to the contact related to the second user includes the mail notification. The control circuit 1011 acquires, from the user data, a mail address associated with the identification information of the second user. The control circuit 1011 controls the network communication module 104 to control the mail notification to the mail address related to the second user. The control circuit 1011 controls the network communication module 104 to control the transmission of an email related to mistakenly taking away the facsimile print. The email includes the message of mistakenly taking away the facsimile print. The email may include the name of the first user at the address of the facsimile data. The email is an example of the mail notification. The network communication module 104 transmits the email to the mail address of the second user via the network NWb.

In ACT 307, the control circuit 1011 may control the notification to the contact related to the first user. The notification to the contact related to the first user is a notification related to the case of mistakenly taking away the facsimile print. The notification to the contact related to the first user includes the message of mistakenly taking away the facsimile print. The notification to the contact related to the first user may include the name of the second user who mistakenly took away the facsimile print. The control circuit 1011 can acquire, from the user data, the name of the second user associated with the identification information of the second user. The notification to the contact related to the first user includes at least either one of the voice notification or the mail notification.

A case will be described in which the notification to the contact related to the first user includes the voice notification. The control circuit 1011 acquires, from the user data, a telephone number associated with the identification information of the first user. The control circuit 1011 controls the telephone module 103 to control the voice notification to the telephone number related to the first user. The control circuit 1011 controls the telephone module 103 to control the transmission of the voice data related to the case of mistakenly taking away the facsimile print. The voice data includes the message of mistakenly taking away the facsimile print. The voice data may include the name of the second user who mistakenly took away the facsimile print. The telephone module 103 transmits the voice data to the telephone 3 having a telephone number related to the first user via the network NWa.

A case will be described in which the notification to the contact related to the first user includes the mail notification. The control circuit 1011 acquires, from the user data, a mail address associated with the identification information of the first user. The control circuit 1011 controls the network communication module 104 to control the mail notification to the mail address related to the first user. The control circuit 1011 controls the network communication module 104 to control the transmission of an email related to the case of mistakenly taking away the facsimile print. The email includes the message of mistakenly taking away the facsimile print. The email may include the name of the second user who mistakenly took away the facsimile print. The email is an example of the mail notification. The network communication module 104 transmits the email to the mail address of the first user via the network NWb.

According to the above-described third example, the image forming device 1 can detect the presence or absence of the facsimile print in the tray 18 based on the sensing data. The image forming device 1 can detect, based on the sensing data acquired by the sensing device, that the facsimile print is not present in the tray 18 after the second user uses the image forming device 1. Accordingly, the image forming device 1 can continuously detect the presence or absence of the facsimile print in the tray 18 after the second user uses the image forming device 1.

According to the above-described third example, the image forming device 1 can control the notification to the contact related to the second user if the facsimile print is not present in the tray 18 after the second user uses the image forming device 1. Accordingly, the image forming device 1 can notify the second user who mistakenly took away the facsimile print. The image forming device 1 can cause, by the notification, the second user to recognize the fact of mistakenly taking away the facsimile print. Thus, the image forming device 1 can prevent the facsimile print from being lost.

According to the above-described third example, the image forming device 1 can control the notification to the contact related to the first user if the facsimile print is not present in the tray 18 after the second user uses the image forming device 1. Accordingly, the image forming device 1 can notify the first user whose facsimile print is mistakenly taken away. The image forming device 1 can cause, by the notification, the first user to recognize that another user mistakenly took away the facsimile print. Thus, the image forming device 1 can urge the first user to collect the facsimile print.

According to the above-described third example, the image forming device 1 can detect, based on the authentication of the second user, that the second user uses the image forming device 1. Accordingly, the image forming device 1 can easily acquire the contact when controlling the notification.

In the embodiments described above, an example is described in which the control circuit 1011 detects the presence or absence of the facsimile print in the tray 18 based on the filming data. However, the embodiments are not limited thereto. The control circuit 1011 may use sensing data acquired by a sensor that detects a print placed on the tray 18. The sensor may be a non-contact type sensor such as an optical type sensor. The type of sensor is not limited thereto. The sensor is an example of the sensing device.

In the above-described embodiments, an example is described in which the control circuit 1011 authenticates the second user via the card reader 17. However, the embodiments are not limited thereto. The control circuit 1011 may authenticate the second user via a camera. In this example, the control circuit 1011 may authenticate the second user by biometric authentication based on the filming data acquired by the camera. The camera is an example of the electronic device for authentication. The camera is a camera capable of filming a user who uses the image forming device 1 with the vicinity of the image forming device 1 as the filming range. The camera may be at least the same camera as the camera 16 whose filming range is the tray 18, or may be a camera different from the camera 16.

The program may be transferred in a state of being stored in an electronic device, or may be transferred in a state of not being stored in an electronic device. In the latter case, the program may be transferred via a network, or may be transferred in a state of being recorded in a recording medium. The recording medium is a non-transitory tangible medium. The recording medium is a computer-readable medium. The recording medium may be any medium such as a CD-ROM or a memory card as long as the medium can store a program and can be read by a computer, and a form of the recording medium is not limited.

While certain embodiments have been described, these embodiments have been presented by way of example only, and are not intended to limit the scope of invention. Indeed, the novel device and methods described herein may be embodied in a variety of other forms; furthermore, various omissions, substitutions and changes in the form of the device and methods described herein may be made without departing from the spirit of the inventions. The accompanying claims and their equivalents are intended to cover such forms or modifications as would fall within the scope and spirit of the inventions.

What is claimed is:

1. An image forming device, comprising:
a facsimile communication module configured to receive facsimile data;
a printer configured to form, on a sheet, an image based on the facsimile data; and
a control circuit configured to extract an address from the facsimile data and generate a voice notification to a contact related to the address.

2. The image forming device according to claim 1, further comprising:
a tray on which the sheet having the image based on the facsimile data is placed, wherein
if the sheet having the image is present on the tray after a predetermined time elapses from the generation of the voice notification, the control circuit generates another voice notification to the contact after the predetermined time elapses.

3. The image forming device according to claim 2, wherein
the control circuit detects, based on sensing data acquired by a sensor, that the sheet having the image is present on the tray after the predetermined time elapses.

4. The image forming device according to claim 1, wherein
if the facsimile data includes a predetermined keyword, the control circuit extracts the predetermined keyword, and
the voice notification includes the predetermined keyword.

5. The image forming device according to claim 1, further comprising:
a tray on which a sheet having an image based on the facsimile data is placed, wherein
if the sheet having the image, which is present in the tray before a second user different from a first user at the address uses the image forming device, is not present on the tray after the second user uses the image forming device, the control circuit generates a notification to a contact related to the second user.

6. The image forming device according to claim 5, wherein
if the sheet having the image is not present on the tray after the second user uses the image forming device, the control circuit generates a notification to a contact related to the first user.

7. The image forming device according to claim 5, wherein
the control circuit detects, based on sensing data acquired by a sensing device, that the sheet having the image is not present on the tray after the second user uses the image forming device.

8. The image forming device according to claim 5, wherein
the control circuit detects, based on authentication of the second user, that the second user uses the image forming device.

9. The image forming device according to claim 1, wherein
the contact is a telephone number or an e-mail address.

10. A facsimile processing system comprising a first image forming device and a second image forming device, wherein
the first image forming device comprises:
a facsimile communication module configured to receive facsimile data transmitted from the second image forming device;
a printer configured to form, on a sheet, an image based on the facsimile data; and
a control circuit configured to extract an address from the facsimile data and generate a voice notification to a contact related to the address.

11. The facsimile processing system according to claim 10, further comprising:
a tray on which the sheet having the image based on the facsimile data is placed, wherein
if the sheet having the image is present on the tray after a predetermined time elapses from the generation of the voice notification, the control circuit generates another voice notification to the contact after the predetermined time elapses.

12. The facsimile processing system according to claim 10, further comprising:
a tray on which a sheet having an image based on the facsimile data is placed, wherein
if the sheet having the image, which is present in the tray before a second user different from a first user at the address uses the image forming device, is not present on the tray after the second user uses the image forming device, the control circuit generates a notification to a contact related to the second user.

13. A facsimile processing method, comprising:
forming an image on a sheet based on facsimile data received by a facsimile communication module;
extracting an address from the facsimile data; and
generating a voice notification to a contact related to the address.

14. The facsimile processing method according to claim 13, further comprising:
placing the sheet having the image based on the facsimile data on a tray;
if the sheet having the image is present on the tray after a predetermined time elapses from the generation of the voice notification, generating another voice notification to the contact after the predetermined time elapses.

15. The facsimile processing method according to claim 14, further comprising:
detecting, based on sensing data acquired by a sensor, that the sheet having the image is present on the tray after the predetermined time elapses.

16. The facsimile processing method according to claim 13, further comprising:
if the facsimile data includes a predetermined keyword, extracting the predetermined keyword, wherein
the voice notification includes the predetermined keyword.

17. The facsimile processing method according to claim 13, further comprising:
placing a sheet having an image based on the facsimile data on a tray;
if the sheet having the image, which is present in the tray before a second user different from a first user at the address uses the image forming device, is not present on the tray after the second user uses the image forming device, generating a notification to a contact related to the second user.

18. The facsimile processing method according to claim 17, further comprising:
if the sheet having the image is not present on the tray after the second user uses the image forming device, generating a notification to a contact related to the first user.

19. The facsimile processing method according to claim 17, further comprising:
detecting, based on sensing data acquired by a sensing device, that the sheet having the image is not present on the tray after the second user uses the image forming device.

20. The facsimile processing method according to claim 17, further comprising:
detecting, based on authentication of the second user, that the second user uses the image forming device.
